(19) United States
(12) Patent Application Publication
(10) Pub. No.: US 2014/0278606 A1
(43) Pub. Date: Sep. 18, 2014

(54) System and Methods For Exchanging Property, Services and Reservations

(71) Applicant: J. Michael Robison, Atlanta, GA (US)

(72) Inventor: J. Michael Robison, Atlanta, GA (US)

(21) Appl. No.: 14/210,519

(22) Filed: Mar. 14, 2014

Related U.S. Application Data
(60) Provisional application No. 61/782,268, filed on Mar. 14, 2013.

(51) Int. Cl. G06Q 50/16; G06Q 10/02

(52) U.S. Cl. CPC G06Q 50/163; G06Q 10/02
USPC 705/5

(57) ABSTRACT

A representative exchange system is disclosed herein comprising a plurality of computing devices, a network that interconnects the plurality of computing devices, and an exchange server that is interconnected to the plurality of computing devices by way of the network. The exchange server includes a processing device and memory that includes an exchange manager having instructions that are executed by the processing device. The instructions include the following logics: receive exchange information associated with a property, services, and/or reservations, wherein the exchange information includes a selling price; determine whether the property, services, and/or reservations has been purchased by a first purchaser based on the selling price, and whether the first purchaser has resold the property, services, and/or reservations; and responsive to determining that the property, services, and/or reservations has been resold to a second purchaser, transfer the title of the property, services, and/or reservations from the originator to the second purchaser, thereby bypassing a transfer of title of the property, services, and/or reservations to the first purchaser.

### PRIORITY CLAIM

This application claims priority to co-pending U.S. Provisional Application Ser. No. 61/782,268 filed on Mar. 14, 2013, which is fully incorporated herein by reference.

### TECHNICAL FIELD

The present disclosure is generally related to exchanging property, services, and/or reservations and, more particularly, is related to systems and methods for allowing a party that has purchased property, services, and/or reservations to offer that property, services, and/or reservations for resale such that a transfer of the purchased property, services, and/or reservations can be accomplished from an originator of the property, services, and/or reservations to a purchaser or a series of subsequent purchasers, before delivery of the property, services, and/or reservation occurs thereby bypassing the transfer of the property, services, and/or reservations to a reseller.

### BACKGROUND

Traditional transaction involves an originator selling an item, then immediately (or shortly thereafter) transferring title to a purchaser. This methodology can create inefficiencies in the marketplace.

Desirable in the art is an improved method of exchanging properties and/or services that would improve upon the conventional method of managing exchanging properties and/or services.

### SUMMARY

A representative exchange system is disclosed herein comprising a plurality of computing devices, a network that interconnects the plurality of computing devices, and an exchange server that is interconnected to the plurality of computing devices by way of the network. The exchange server includes a processing device and memory that includes an exchange manager having instructions that are executed by the processing device. The instructions include the following logics: receive exchange information associated with a property, services, and/or reservations, wherein the exchange information includes a selling price; determine whether the property, services, and/or reservations has been purchased by a first purchaser based on the selling price, and whether the first purchaser has resold the property, services, and/or reservations; and responsive to determining that the property, services, and/or reservations has been resold to a second purchaser, transfer the title of the property, services, and/or reservations from the originator to the second purchaser, thereby bypassing a transfer of title of the property, services, and/or reservations to the first purchaser.

The exchange system can have instructions that include the logic of displaying a resell price; and responsive to determining that the property, services, and/or reservations has been resold to the second purchaser based on the resell price, providing proceeds to the originator based on the purchase of the property, services, and/or reservations made by the first purchaser, proceeds to the first purchaser of the property, services, and/or reservations made by the second purchaser less a commission paid to the originator. The second purchaser, and any subsequent purchasers, may also resell the property, services, and/or reservations through the exchange system in the same way. Optionally, the exchange system may be configured to provide the first purchaser, and any subsequent purchaser thereafter, a commission upon the resale of the property, services, and/or reservations through the exchange system.

Other systems, devices, methods, features of the invention will be or will become apparent to one skilled in the art upon examination of the following figures and detailed description. It is intended that all such systems, devices, methods, features be included within the scope of the invention, and be protected by the accompanying claims.

### BRIEF DESCRIPTION OF DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, the reference numerals designate corresponding parts throughout the several views. While several embodiments are described in connection with these drawings, there is no intent to limit the disclosure to the embodiment or embodiments disclosed herein. On the contrary, the intent is to cover all alternatives, modifications, and equivalents.

FIG. 1 is a block diagram that illustrates an embodiment of a system having an exchange manager that allows a party that has purchased property, services, and/or reservations to offer that property, services, and/or reservations for resale such that a transfer of the purchased property, services, and/or reservations can be accomplished from an originator of the property, services, and/or reservations to a purchaser, thereby bypassing the transfer of the property, services, and/or reservations to the reseller;

FIG. 2 is a high-level block diagram that illustrates an embodiment of an exchange system, such as that shown in FIG. 1;

FIG. 3 is a sequence diagram that illustrates an embodiment of an exchange system, such as that shown in FIG. 2;

FIG. 4 is a high-level flow diagram that illustrates an embodiment of the architecture, functionality, and/or operation of an exchange manager, such as that shown in FIG. 1;

FIG. 5 is a more detailed flow diagram that illustrates an embodiment of the architecture, functionality, and/or operation of an exchange manager, such as that shown in FIG. 4; and

FIG. 6 is a block diagram illustrating an exemplary architecture for a generic computer that is similar to the architecture of the computing device, local server and central server having an exchange manager, such as that shown in FIG. 1.

### DETAILED DESCRIPTION

Exemplary systems are first discussed with reference to the figures. Although these systems are described in detail, they are provided for purposes of illustration only and various modifications are feasible. After the exemplary systems are described, examples of flow diagrams of the systems are provided to explain the manner in which a party that has purchased property, services, and/or reservations can offer that property, services, and/or reservations for resale such that a transfer of the purchased property, services, and/or reservations can be accomplished from an originator of the property, services, and/or reservations to a purchaser, thereby bypassing the transfer of the property, services, and/or reservations to a reseller.

FIG. 1 is a block diagram that illustrates an embodiment of a system 100 having an exchange manager 125. The system 100 can include exchange server 115 at a premise of an exchange entity 110, and computing devices 120A-B and portable computing devices 120C at respective premises 118, 130A-B of an originator 118 and purchasers 130A-B. The computing devices 120A-B can include, but not limited to, desktop computers, laptops, and netbooks. The portable computing device 120C can include, but not limited to, smart phones, tablets, smart glass, and smart watch. The reference numeral 120A-C is hereinafter referred to as computing devices for simplicity and easier read.

Each exchange server 115 and computing devices 120A-C is installed with an exchange manager 125A-D. The computing devices 120A-C can communication with the exchange server 115 via a network 105, e.g., Internet, LAN, and WAN. The exchange manager 125 can aide a party that has purchased property, services, and/or reservations to offer that property, services, and/or reservations for resale such that a transfer of the purchased property, services, and/or reservations can be accomplished from an originator of the property, services, and/or reservations to a purchaser, thereby bypassing the transfer of the property, services, and/or reservations to the reseller. The exchange manager 125 is further described in connection to FIGS. 2-5.

FIG. 2 is a high-level block diagram that illustrates an embodiment of an exchange system 215, such as that shown in FIG. 1. An originator 118 can have properties, services, and/or reservations 205 wants to sell using an exchange system 215. The originator 118 can communicate with the exchange system 215 via line 210. The purchasers 135A-C can communicate with the exchange system 215 via lines 220A-C, respectively. For example, the purchasers 135A-C can be a first, second and final purchaser, respectively. The exchange system 215 can aid the originator 118 that has the property, services, and/or reservations to offer that property, services, and/or reservations 205 for resale such that a transfer of the purchased property, services, and/or reservations can be accomplished from the originator 118 of the property, services, and/or reservations 205 to the final purchaser 135C, thereby bypassing the transfer of the property, services, and/or reservations to the first and second purchasers 135A-B.

FIG. 3 is a sequence diagram that illustrates an embodiment of an exchange system 215, such as that shown in FIG. 2. Beginning with line 305, an originator 118 inputs selling information regarding his/her property, services, and/or reservations 205 (FIG. 2), e.g., selling price, description, time period of exchange, etc., into the exchange system 215. The exchange system 215 processes and displays the selling information via line 310. A purchaser 135 inputs buying and reselling information regarding the property, services, and/or reservations 205 into the exchange system 215 via line 315. The exchange system 215 processes the buying information and provides the proceeds of the purchase to the originator via line 320.

The exchange system 215 confirms the purchase of the property, services, and/or reservations 205, and processes and displays the reselling information, e.g., reselling price, description, time period of the exchange, etc., via lines 325, 330. A purchaser 135B inputs to the exchange system 215 the buying information regarding the property, services, and/or reservations based on the reselling information via line 335.

In this example, purchasers 135A, B becomes a reseller and a final purchaser. The exchange system 215 processes the buying information from the purchaser 135B, and provides a commission and proceeds of the purchase by purchaser 135B to the originator 118 and reseller 135A via lines 340, 345, respectively. The originator 118 transfers the title of the property, services, and/or reservations 205 to the purchaser 135B, thereby bypassing the transfer of the property, services, and/or reservations to the reseller 135A. Alternatively or additionally, the purchaser 135B can resell the property, services, and/or reservations to another purchaser and the sequence can repeat similarly at line 315.

FIG. 4 is a high-level flow diagram that illustrates an embodiment of the architecture, functionality, and/or operation of an exchange manager 125, such as that shown in FIG. 1. Beginning with blocks 405, 410, the exchange manager 125 receives exchange information (e.g., a selling price) associated with a property, services, and/or reservations 205 (FIG. 2), and determines whether the property, services, and/or reservations 205 has been purchased by a first purchaser 135A (FIG. 2) based on the selling price. Responsive to the property, services, and/or reservations 205 not being purchased, the exchange manager 125 continues to receive exchange information from potential purchasers 135 at block 405. Responsive to the property, services, and/or reservations 205 being purchased, the exchange manager 125 in block 415 determines whether the first purchaser 135A has resold the property, services, and/or reservations 205. Responsive to the property, services, and/or reservations 205 not being resold, the exchange manager 125 continues to receive exchange information from another potential purchaser 135 at block 405.

Responsive to determining that the property, services, and/or reservations 205 has been resold to a second purchaser 135B (FIG. 2), the exchange manager 125 in block 420 transfers the title of the property, services, and/or reservations 205 from the originator 118 to the second purchaser 135B, thereby bypassing a transfer of title of the property, services, and/or reservations 205 to the first purchaser 135A. In block 425, the exchange manager 125 provides proceeds to the originator 118 based on the purchase of the property, services, and/or reservations 205 made by the first purchaser 135A, proceeds to the first purchaser 135A of the property, services, and/or reservations 205 made by the second purchaser 135B. Optionally, a commission can also be paid to the originator 118 based upon the sale price of the property, services, and/or reservation by the first purchaser or any subsequent purchaser.

FIG. 5 is a more detailed flow diagram that illustrates an embodiment of the architecture, functionality, and/or operation of an exchange manager 125, such as that shown in FIG. 4. Beginning with blocks 505, 510, the exchange manager 125 receives exchange information, e.g., description of an exchange item, a selling price, and exchange time period, associated with a property, services, and/or reservations 205 (FIG. 2), and provides the exchange information to purchasers 135 (FIG. 2) on, for example, the Internet 105 (FIG. 1) to be displayed on a monitor or other similar display devices associated with the computing devices 120A-C. The originator 118 can determine when the exchange time period ends or the exchange manager 125 can make a predetermination of when the exchange time period ends.

In block 515, the exchange manager 125 determines whether the property, services, and/or reservations 205 has been purchased by a first purchaser 135A based on the selling price. Responsive to the property, services, and/or reservations 205 not being purchased, the exchange manager 125 continues to provide the exchange information to potential purchasers 135 at block 510. Responsive to the property, services, and/or reservations 205 being purchased, the exchange manager 125 in block 520 requests from the purchaser a resell price associated with the purchased property, services, and/or reservations. Alternatively or additionally, the exchanger manager 125 can predetermine the resell price and request that the purchaser agree to the resell price until the end of the exchange time period or another purchaser 135 purchases the property, services, and/or reservations 205 at the resell price. The resell price can be a minimum amount above the original selling price predetermined by the exchange manager 125.

In block 525, the exchange manager 125 can determine whether the purchaser 135A provided a resell price associated with the purchased property, services, and/or reservations 205 to the exchange manager 125. Responsive to determining that a resell price was not received from the purchaser 135A, the exchange manager 125 continues to provide the exchange information to other potential purchasers at block 510, for example, by displaying the resell price on a display device via the Internet and repeats blocks 515, 520, and declines the purchase of the property, services, and/or reservations 205 from the purchaser 135A for not receiving a resell price.

Responsive to determining that a resell price was received from the purchaser 135A, the exchange manager 125 in block 530 determines whether the exchange time period has ended for exchanging property, services, and/or reservations 205. Responsive to determining that the exchange time period has not ended, the exchange manager 125 continues to provide the exchange information to other potential purchasers at block 510 and repeats blocks 515, 520, 525.

Responsive to determining that the exchange time period has ended, the exchange manager 125 in block 535 determines the number of purchasers 135 purchased the property, services, and/or reservations 205. Responsive to determining that the property, services, and/or reservations 205 has been sold to one purchaser 135A, the exchange manager 125 confirms and processes the purchase of the property, services, and/or reservations 205 by the one purchaser 135A, and provides the proceeds of the purchase to the originator 118, who transfers the title of the property, services, and/or reservations to the one purchaser 135A.

Responsive to determining that the property, services, and/or reservations has been resold to more than one purchasers 135, the exchange manager 125 transfers the title of the property, services, and/or reservations 205 from the originator 118 to a second purchaser 135B, thereby bypassing a transfer of title of the property, services, and/or reservations 205 to the one purchaser 135A. The exchange manager 125 can provide proceeds to the originator 118 based on the purchase of the property, services, and/or reservations 205 made by the first purchaser 135A, proceeds to the first purchaser 135A of the property, services, and/or reservations 205 made by the second purchaser 135B. The exchange manger 125 can also provide a commission to the originator 118 based on the sale price of the property, services, and/or reservation by the first purchaser or any subsequent purchaser.

Alternatively or additionally, the exchange manager 125 can decline the purchase of the property, services, and/or reservations 205 based on a predetermined number of purchasers, such as having more than one (1) or two (2) purchasers. Alternatively or additionally, the exchange manager 125 can provide confirmation of the purchase of the property, services, and/or reservations 205 based on the selling price and/or the reselling price of the property, services, and/or reservations 205. Alternatively or additionally, the exchange manager 125 can provide tracking information of the purchased property and/or an estimated time of delivery of the purchased service. Alternatively or additionally, the purchase of the property, services, and/or reservations 205 from the originator 118 and the first purchaser 135A is accomplished by auctioning the property, services, and/or reservations 205 based on the selling price and resell price.

The exchange system 215 can be used for numerous items, as long as people are willing to sell and buy them. The items include, but are not limited to, airline tickets, hotel reservations, entertainment/arts tickets (such as, concerts, movies, theater, sports, special events, etc.), restaurant reservations, rental car reservations, doctor's office appointments, spa appointments, boat or other equipment rental reservations, back ordered products and/or services (e.g., consumer goods purchased online such as, clothing, furnishings, electronics, wine, food, supplies, etc.), apartment waiting lists, new automobile waiting list, pet purchase waiting lists, school entry waiting list, bank teller or any other waiting list, and parking spaces (such as when owner moves his/her car).

In the airline ticket example, a customer purchases an airplane ticket from an airline, which retains title to the ticket. The customer can enter a resell price at which the purchaser would transfer or is willing to transfer the rights to the airline ticket. If the airplane ticket was not purchased by another customer based on the resell price before the check-in time, the airline transfers its rights or title of the ticket to the purchaser as soon as the purchaser checks in.

At any time prior to the check-in time and a second or further subsequent customer purchases the airplane ticket based on the resell price, the airline can transfer the title of the airline ticket to the second purchaser via the exchange manager 125, bypassing a transfer of title of the airline ticket to the first purchaser. The exchange manager 125 provides proceeds to the airline based on the purchase of the airline ticket made by the first purchaser, proceeds to the first purchaser of the airline ticket made by the second purchaser less a commission paid to the airline for permitting the resale of the airline ticket to the second or any subsequent purchaser.

In the entertainment ticket example, a customer purchases a concert ticket from a concert ticket provider, which retains title to the concert ticket. The customer can enter a resell price at which the purchaser would transfer or is willing to transfer the rights to the concert ticket. If the concert ticket was not purchased by another customer based on the resell price before the start of the concert, the concert ticket provider transfers its rights or title of the concert ticket to the purchaser as soon as the purchaser picks up the ticket.

At any time prior to the start of the concert a second or further subsequent customer purchases the concert ticket based on the resell price, the concert ticket provider can transfer the title of the concert ticket to the second purchaser via the exchange manager 125, bypassing a transfer of title of the concert ticket to the first purchaser. The exchange manager 125 provides proceeds to the concert ticket provider based on the purchase of the concert ticket made by the first purchaser, proceeds to the first purchaser of the concert ticket based on the sale made by the second or further subsequent purchaser less a commission paid to the concert ticket provided for permitting the resale of the ticket to the second or any subsequent purchaser.

In the consumer goods example, a customer purchases, for example, an electronic device that is back ordered from an electronic manufacturer, which retains title to the electronic device. The customer can enter a resell price at which the purchaser would transfer or is willing to transfer the rights to the electronic device. If the electronic device was not purchased by another customer based on the resell price before the shipment of the electronic device, the electronic manufacturer transfers its rights or title of the electronic device to the purchaser as soon as the electronic device is shipped.

At any time prior to the shipment of the electronic device a second or further subsequent customer purchases the electronic device based on the resell price, the electronic manufacturer can transfer the title of the electronic device to the second or further subsequent purchaser via the exchange manager 125, bypassing a transfer of title of the electronic device to the first purchaser. The exchange manager 125 provides proceeds to the electronic manufacturer based on the purchase of the electronic device made by the first purchaser, proceeds to the first purchaser of the electronic device based on the sale to the second or further subsequent purchasers less a commission paid to the electronic manufacturer for permitting the resale of the electronic device to the second or any subsequent purchaser.

In the restaurant reservations example, a customer books, for example, a dinner deal and reservation online from a restaurant, which retains title to the dinner deal and reservation. The customer can enter a resell price at which the purchaser would transfer or is willing to transfer the rights to the dinner deal and reservation. If the dinner deal and reservation was not purchased by another customer based on the resell price before the time of the dinner reservation, the restaurant transfers its rights or title of the dinner deal and reservation to the purchaser as soon as the purchaser checks into the restaurant.

At any time prior to the time of the dinner reservation and a second customer purchases the dinner deal and reservation based on the resell price, the restaurant can transfer the title of the dinner deal and reservation to the second or further subsequent purchaser via the exchange manager 125, bypassing a transfer of title of the dinner deal and reservation to the first purchaser. The exchange manager 125 provides proceeds to the restaurant based on the purchase of the dinner deal and reservation made by the first purchaser, proceeds to the first purchaser based on the sale of the dinner deal and reservation to a second or subsequent purchaser, less a commission paid to the restaurant for permitting the resale of the dinner deal and reservation to the second or any subsequent purchaser.

FIG. 6 is a block diagram illustrating an exemplary architecture for a generic computer 600 that is similar to the architecture of the computing device 120, such as that shown in FIG. 1. As indicated in FIG. 6, the computing generic computer 600 comprises a processing device 610, memory 615, one or more user interface devices 620, one or more I/O devices 630, and one or more networking devices 640, each of which is connected to a local interface 650. The processing device 610 can include any custom made or commercially available processor, a central processing unit (CPU) or an auxiliary processor among several processors associated with the generic computer 600, a semiconductor based microprocessor (in the form of a microchip), or a macroprocessor. The memory 615 can include any one or a combination of volatile memory elements (e.g., random access memory (RAM, such as DRAM, SRAM, etc.)) and nonvolatile memory elements (e.g., ROM, hard drive, tape, CDROM, etc.).

The one or more user interface devices 620 comprise those components with which the user (e.g., administrator) can interact with the generic computer 600. Where the generic computer 600 comprises a server computer or similar device, these components can comprise those typically used in conjunction with a PC such as a keyboard and mouse.

The one or more I/O devices 630 comprise components used to facilitate connection of the generic computer 600 to other devices and therefore, for instance, comprise one or more serial, parallel, small system interface (SCSI), universal serial bus (USB), or IEEE 1394 (e.g., Firewire™) connection elements. The networking devices 640 comprise the various components used to transmit and/or receive data over networks (not shown), where provided. By way of example, the networking devices 640 include a device that can communicate both inputs and outputs, for instance, a modulator/demodulator (e.g., modem), a radio frequency (RF) or infrared (IR) transceiver, a telephonic interface, a bridge, a router, as well as a network card, etc.

The memory 615 normally comprises various programs (in software and/or firmware) including an operating system (O/S) 625 and the exchange manager 125 described above. The O/S 625 controls the execution of programs, and provides scheduling, input-output control, file and data management, memory management, and communication control and related services.

The systems and methods disclosed herein can be implemented in software, hardware, or a combination thereof. In some embodiments, the system and/or method is implemented in software that is stored in a memory and that is executed by a suitable microprocessor (μP) situated in a computing device. However, the systems and methods can be embodied in any computer-readable medium for use by or in connection with an instruction execution system, apparatus, or device. Such instruction execution systems include any computer-based system, processor-containing system, or other system that can fetch and execute the instructions from the instruction execution system. In the context of this disclosure, a “computer-readable medium” can be any means that can contain, store, communicate, propagate, or transport the program for use by, or in connection with, the instruction execution system. The computer readable medium can be, for example, but not limited to, a system or propagation medium that is based on electronic, magnetic, optical, electromagnetic, infrared, or semiconductor technology.

Specific examples of a computer-readable medium using electronic technology would include (but are not limited to) the following: an electrical connection (electronic) having one or more wires; a random access memory (RAM); a read-only memory (ROM); an erasable programmable read-only memory (EPROM or Flash memory). A specific example using magnetic technology includes (but is not limited to) a portable computer diskette. Specific examples using optical technology include (but are not limited to) optical fiber and compact disc read-only memory (CD-ROM).

Note that the computer-readable medium could even be paper or another suitable medium on which the program is printed. Using such a medium, the program can be electronically captured (using, for instance, optical scanning of the paper or other medium), compiled, interpreted or otherwise processed in a suitable manner, and then stored in a computer memory. In addition, the scope of the certain embodiments of the present disclosure includes embodying the functionality of the preferred embodiments of the present disclosure in logic embodied in hardware or software-configured mediums.

It should be noted that any process descriptions or blocks in flowcharts should be understood as representing modules, segments, or portions of code which include one or more executable instructions for implementing specific logical functions or steps in the process. As would be understood by those of ordinary skill in the art of the software development, alternate embodiments are also included within the scope of the disclosure. In these alternate embodiments, functions may be executed out of order from that shown or discussed, including substantially concurrently or in reverse order, depending on the functionality involved.

This description has been presented for purposes of illustration and description. It is not intended to be exhaustive or to limit the disclosure to the precise forms disclosed. Obvious modifications or variations are possible in light of the above teachings. The embodiments discussed, however, were chosen to illustrate the principles of the disclosure, and its practical application. The disclosure is thus intended to enable one of ordinary skill in the art to use the disclosure, in various embodiments and with various modifications, as are suited to the particular use contemplated. All such modifications and variation are within the scope of this disclosure, as determined by the appended claims when interpreted in accordance with the breadth to which they are fairly and legally entitled.

Therefore, having thus described the disclosure, at least the following is claimed:

1. An exchange system comprising:
a plurality of computing devices;
a network that interconnects the plurality of computing devices; and
an exchange server that is interconnected to the plurality of computing devices by way of the network, wherein the exchange server includes a processing device; and memory including an exchange manager which has instructions that are executed by the processing device, the instructions including the following logics:
receive exchange information associated with a property, services, and/or reservations, the exchange information including a selling price;
determine whether the property, services, and/or reservations has been purchased by a first purchaser based on the selling price, and whether the first purchaser has resold the property, services, and/or reservations; and
responsive to determining that the property, services, and/or reservations has been resold to a second purchaser, transfer the title of the property, services, and/or reservations from the originator to the second purchaser, thereby bypassing a transfer of title of the property, services, and/or reservations to the first purchaser.

2. The exchange system as defined in claim 1, wherein the exchange manager has instructions that include the logic of:
displaying a resell price; and
responsive to determining that the property, services, and/or reservations has been resold to the second purchaser based on the resell price, providing proceeds to the originator based on the purchase of the property, services, and/or reservations made by the first purchaser, proceeds to the first purchaser of the property, services, and/or reservations made by the second purchaser less a commission paid to the originator.

3. The exchange system as defined in claim 2, wherein the received exchange information includes an end of time period for exchanging properties and/or services, wherein the end of time period occurs after a resell price has been provided by the first purchaser.

4. The exchange system as defined in claim 3, wherein the exchange manager has instructions that include the logic of displaying the selling price and resell price of the property, services, and/or reservations and the end of time period for exchanging properties and/or services.

5. The exchange system as defined in claim 3, wherein the end of time period is predetermined.

6. The exchange system as defined in claim 1, wherein the exchange manager has instructions that further include the logic of providing confirmation of the purchase of the property, services, and/or reservations based on the selling price and/or the reselling price of the property, services, and/or reservations.

7. The exchange system as defined in claim 1, wherein the exchange manager has instructions that further include the logic of providing tracking information of the purchased property and/or an estimated time of delivery of the purchased service.

8. The exchange system as defined in claim 1, wherein the exchange manager has instructions that further include the logic of requesting a resell price from a purchaser and responsive to not receiving the resell price the purchaser, declining the purchase of the property, services, and/or reservations.

9. The exchange system as defined in claim 1, wherein the resell price is predetermined.

10. The exchange system as defined in claim 1, wherein the exchange manager has instructions that include the logic of declining the purchase of the property, services, and/or reservations based on a predetermined number of purchasers.

11. The exchange system as defined in claim 1, wherein the purchase of the property, services, and/or reservations from the originator and the first purchaser is accomplished by auctioning the property, services, and/or reservations based on the selling price and resell price.

12. An exchange manager that is stored in memory at a computing device, wherein the exchange manager has instructions that are executed by a processing device at the computing device, the instructions of the exchange manager comprising:
receiving exchange information and a selling price associated with a property, services, and/or reservations;
determining whether the property, services, and/or reservations has been purchased by a first purchaser based on the selling price, and whether the first purchaser has resold the property, services, and/or reservations; and
responsive to determining that the property, services, and/or reservations has been resold to a second purchaser, transferring the title of the property, services, and/or reservations from the originator to the second purchaser, thereby bypassing a transfer of title of the property, services, and/or reservations to the first purchaser.

13. The exchange manager as defined in claim 12, further comprising the logic of displaying a resell price; and responsive to determining that the property, services, and/or reservations has been resold to the second purchaser based on the resell price, providing proceeds to the originator based on the purchase of the property, services, and/or reservations made by the first purchaser, proceeds to the first purchaser of the property, services, and/or reservations made by the second purchaser less a commission paid to the originator.

14. The exchange manager as defined in claim 13, wherein the received exchange information includes an end of time period for exchanging properties and/or services, wherein the end of time period occurs after a resell price has been provided by the first purchaser.

15. The exchange manager as defined in claim 14, further comprising the logic of displaying the selling price and resell price of the property, services, and/or reservations and the end of time period for exchanging properties and/or services.

16. The exchange manager as defined in claim 12, further comprising the logic of providing confirmation of the purchase of the property, services, and/or reservations based on the selling price and/or the reselling price of the property, services, and/or reservations.

17. The exchange manager as defined in claim 12, further comprising the logic of providing tracking information of the purchased property and/or an estimated time of delivery of the purchased service.

18. The exchange manager as defined in claim 11, wherein the purchase of the property, services, and/or reservations from the originator and the first purchaser is accomplished by auctioning the property, services, and/or reservations based on the selling price and resell price.

19. The method of exchanging property using a plurality of computing devices that are interconnected by a network, the method comprising:
receiving exchange information associated with a property, services, and/or reservations and a selling price of the property, services, and/or reservations;
determining whether the property, services, and/or reservations has been purchased by a first purchaser based on the selling price, and whether the first purchaser has resold the property, services, and/or reservations; and
responsive to determining that the property, services, and/or reservations has been resold to a second purchaser, transferring the title of the property, services, and/or reservations from the originator to the second purchaser, thereby bypassing a transfer of title of the property, services, and/or reservations to the first purchaser.

20. The method as defined in claim 19, further comprising:
displaying a resell price; and
responsive to determining that the property, services, and/or reservations has been resold to the second purchaser based on the resell price, providing proceeds to the originator based on the purchase of the property, services, and/or reservations made by the first purchaser, proceeds to the first purchaser of the property, services, and/or reservations made by the second purchaser less a commission paid to the originator.
